(19) United States
(12) Patent Application Publication
(10) Pub. No.: US 2016/0278088 A1
(43) Pub. Date: Sep. 22, 2016

(54) LBT Operation Based on Channel Activity and/or Traffic Load

(71) Applicant: Telefonaktiebolaget L M Ericsson (publ), Stockholm (SE)

(72) Inventors: Jung-Fu Cheng, Fremont, CA (US); Junaid Ansari, Aachen (DE); Sorour Falahati, Stockholm (SE); Du Ho Kang, Sollentuna (SE); Havish Koorapaty, Saratoga, CA (US); Daniel Larsson, Vallentuna (SE); Amitav Mukherjee, Santa Clara, CA (US)

(21) Appl. No.: 14/660,866

(22) Filed: Mar. 17, 2015

(51) Int. Cl. H04W 72/04; H04W 16/14; H04L 12/807

(52) U.S. Cl. CPC H04W 72/0453; H04L 47/27; H04W 16/14; H04W 72/0406; H04W 84/12

(57) ABSTRACT

A method for operating a radio node (10) for a wireless communication network is described. The radio node (10) is adapted for performing a Listen-Before-Talk, LBT, procedure to determine whether accessing at least one carrier for transmission of data is allowed. The method comprises adjusting the LBT procedure based on operating conditions, wherein adjusting the LBT procedure includes changing a contention window size and/or a random backoff number of the LBT procedure; and/or changing scheduling of data for the at least one carrier; and/or changing a defer period or arbitration interframe spaces. There are also disclosed a corresponding node, system, program product and storage medium.

### TECHNICAL FIELD

This disclosure pertains to Listen-Before-talk based access to carrier in wireless communication networks, in particular in the context of mobile telecommunication.

### BACKGROUND

In wireless communication system utilizing unlicensed spectra, like WLAN (Wireless Local Area Network), before transmitting data, a node usually has to perform a Listen-Before-Talk (LBT) procedure to determine whether the carrier (of the unlicensed spectrum used) it wants to access is available for use. In contrast, many mobile communication systems used licensed spectra, and do not utilize such LBT procedures, as the access to the carriers is strongly controlled by the network, respectively base station. However, current developments in mobile telecommunications allow the use of unlicensed spectra for increased data throughput, in particular in addition to licensed spectra, e.g. in the context of carrier aggregation (CA).

In typical deployments of WLAN, e.g. according to Wifi, carrier sense multiple access with collision avoidance (CSMA/CA) is used for medium access. This means that the channel or carrier is sensed to perform a clear channel assessment (CCA), and a transmission is initiated only if the channel or carrier is declared as idle. In case the channel or carrier is declared as Busy, the transmission is essentially deferred until the channel is deemed to be Idle. When the range of several APs (Access Points, e.g. WLAN node) using the same frequency overlap, this means that all transmissions related to one AP might be deferred in case a transmission on the same carrier or frequency to or from another AP which is within range can be detected. Effectively, this means that if several APs are within range, they will have to share the channel or carrier in time, and the throughput for the individual APs may be severely degraded. A general illustration of this listen before talk (LBT) mechanism is shown in FIG. 1.

After a Wifi station (as an example of a WLAN node) A transmits a data frame to a station B, station B shall transmit an ACK frame (Acknowledgement frame) back to station A with a delay of 16 μs. Such an ACK frame is transmitted by station B without performing a LBT operation. To prevent another station interfering with such an ACK frame transmission, a station shall defer for a duration of 34 μs (referred to as DIFS) after the channel is observed to be occupied before assessing again whether the channel is occupied.

Therefore, a station that wishes to transmit, first performs a CCA (Clear Channel Assessment) by sensing the medium (carrier or channel) for a fixed duration DIFS. If the medium is idle, then the station assumes that it may take ownership of the medium (comprising accessing and/or transmitting) and begin a frame exchange sequence. If the medium is busy, the station waits for the medium to go idle, defers for DIFS, and waits for a further random backoff period.

To further prevent a station from occupying the channel or carrier continuously and thereby prevent other stations from accessing the channel or carrier, it is required for a station wishing to transmit again after a transmission is completed to perform a random backoff.

The PIFS is used to gain priority access to the medium, and is shorter than the DIFS duration. Among other cases, it can be used by STAs operating under PCF (Point coordination Function), to transmit Beacon Frames with priority. At the nominal beginning of each Contention-Free Period (CFP), the PC shall sense the medium. When the medium is determined to be idle for one PIFS period (generally 25 μs), the PC shall transmit a Beacon frame containing the CF Parameter Set element and a delivery traffic indication message element.

In the above basic protocol, when the medium becomes available, multiple Wi-Fi stations may be ready to transmit, which can result in collision. To reduce collisions, stations intending to transmit select a random backoff counter and defer for that number of slot channel idle times. The random backoff counter is selected as a random integer drawn from a uniform distribution over the interval of [0, CW]. The default size of the random backoff window, CWmin, is set in the IEEE specs. Note that collisions can still happen even with this random backoff protocol when they are many stations contending for the channel access. Hence, to reduce continuous collisions, the backoff window size CW is doubled whenever the station detects a collision of its transmission up to a limit, CWmax, also set in the IEEE specs. When a station succeeds in a transmission without collision, it resets its random backoff window size back the default value CWmin.

In the context of the expected increase in use of wireless devices and, in particular, the use of unlicensed spectra for mobile communication, for example in the context of Licensed-Assisted Access (LAA), the LBT procedure used for WLAN is unlikely to ensure fair access for all nodes wanting access to certain carriers or channels, in particular in an unlicensed spectrum.

Moreover, existing random backoff contention window adaptation protocols are based on the reception of a single ARQ feedback value (ACK/NACK) that is received after the transmission of a burst of data. In the case of LTE, a hybrid ARQ (HARQ) protocol is followed instead of a simple ARQ protocol. Thus, multiple retransmissions based on the HARQ feedback may be needed before a single ARQ feedback value at the higher layer is generated.

Secondly, multiple UEs may be communicating with by an eNB in a single subframe. In addition, a single LAA transmission may consist of multiple subframes. Finally, a transmission to or from a single UE may have multiple HARQ feedback values if the transmission is a multi-codeword transmission. Thus there are multiple ways in which multiple feedback values may be received corresponding to a single transmission burst following a successful channel contention. One feature of LTE is that the HARQ feedback is only available after a delay of 4 ms, which corresponds to multiple subframes. WLAN solutions assume the feedback is available after a very short time interval after the transmission ends. Thus, these solutions do not effectively deal with a system like LTE where the feedback delay is much larger.

### SUMMARY

An object of this disclosure is to describe approaches providing fair access to carriers using LBT procedures, in particular in the context of a mobile telecommunications technology or system, which may be using licensed and/or unlicensed spectra, e.g. according to LTE.

There is disclosed a method for operating a radio node for a wireless communication network. The radio node is adapted for performing a Listen-Before-Talk, LBT, procedure to determine whether accessing at least one carrier for transmission of data is allowed. The method comprises adjusting the LBT procedure based on operating conditions, wherein adjusting the LBT procedure includes changing a contention window size and/or a random backoff number of the LBT procedure, and/or changing scheduling of data for the at least one carrier, and/or changing a defer period or arbitration interframe spaces.

Moreover, there is disclosed a radio node for a wireless communication network. The radio node is adapted for performing a Listen-Before-Talk, LBT, procedure to determine whether accessing at least one carrier for transmission of data is allowed, wherein the radio node is further adapted for adjusting the LBT procedure based on operating conditions. Adjusting the LBT procedure includes changing a contention window size and/or a random backoff number of the LBT procedure, and/or changing scheduling of data for the at least one carrier, and/or changing a defer period or arbitration interframe spaces.

In addition, there is disclosed a wireless communication system comprising at least one radio node as described herein and/or adapted for performing any one of the methods described herein.

There is also disclosed a program product comprising code executable by control circuitry, the code causing the control circuitry to control and/or perform any one of the methods described herein.

Moreover, a storage medium storing a program product described herein is disclosed.

The approaches described facilitate fair coexistence operations on carriers accessed using LBT, in particular between co-channel LAA and Wi-Fi when there are a large number of nodes contending for carrier access. Also, efficient handling of system loads is facilitated, in particular in LAA, while allowing spectral coexistence with collocated networks including both Wi-Fi and other LAA systems.

### BRIEF DESCRIPTION OF THE DRAWINGS

FIG. 1 shows an example of a WLAN LBT-procedure;

FIG. 2 shows an example of an LTE downlink resource block;

FIG. 3 shows an example of a pre-defined time structure;

FIG. 4 shows a downlink control structure;

FIG. 5 shows a carrier aggregate;

FIG. 6 shows a LBT procedure;

FIG. 7 shows a CA arrangement with LBT on a SCell;

FIG. 8 shows a method for operating a radio node;

FIG. 9 shows a radio node;

FIG. 10 shows a radio node.

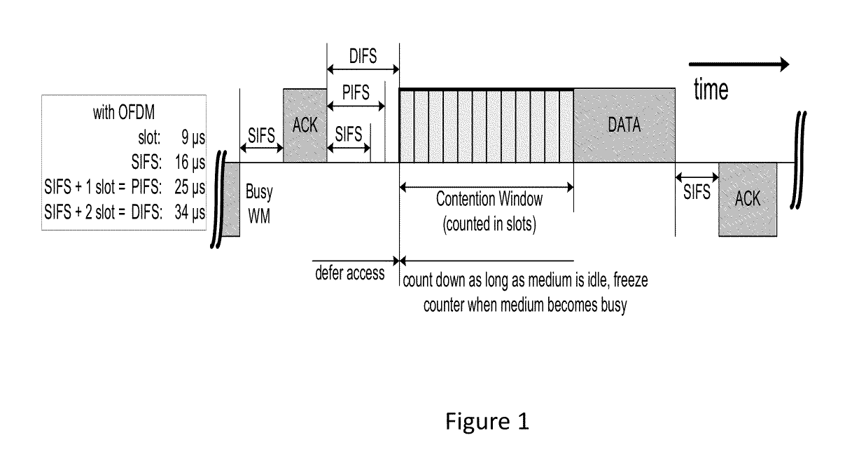

### DETAILED DESCRIPTION

In the context of this specification, a wireless communication network may comprise one or more (radio) nodes or devices adapted for wireless and/or radio communication, in particular according to a pre-determined standard like LTE. It may be considered that one or more radio nodes are connected or connectable to a core network and/or other network nodes of the network, e.g. for transmission of data and/or control. A wireless communication system may comprise at least one radio node (which may be a base station or eNodeB), which may be connected or connectable to a core network, and/or may comprise and/or provide control functionality and/or at least one corresponding control node, e.g. for mobility management and/or data packet transmission and/or charging-related functionality.

A radio node may generally be any device adapted for transmitting and/or receiving radio and/or wireless signals and/or data, in particular communication data, in particular on at least one carrier. The at least one carrier may comprise a carrier accessed based on a LBT procedure (which may be called LBT carrier in the following), e.g. an unlicensed carrier. It may be considered that the carrier is part of a carrier aggregate. A carrier aggregate may generally comprise a plurality of carriers, wherein one carrier may be a primary carrier and/or other carriers may be secondary carriers. It may be considered that carriers of a carrier aggregate are synchronized according to a pre-defined time structure and/or in relation to a synchronizing carrier, which may be a primary carrier. A primary carrier may be a carrier on which control information and/or scheduling data is transmitted and/or which carries one or more control channels for the carrier aggregate and/or one or more carriers. A carrier aggregate may comprise UL carrier/s and/or DL carrier/s. A carrier aggregate may comprise one or more LBT carriers. It may be considered that a carrier aggregate additionally comprises one or more carriers for which no LBT procedure for access is performed, e.g. licensed carriers. A primary carried may be such a carrier, in particular a licensed carrier. Accordingly, in some variants a carrier for which LBT is performed may be in a carrier aggregate comprising at least one carrier for which no LBT is performed, in particular a licensed carrier. A licensed carrier may generally be a carrier licensed for a specific Radio Access Technology (RAT), e.g. LTE. A radio node may in particular be a user equipment or a base station and/or relay node and/or micro- (or pico/femto/nano-)node of or for a network, e.g. an eNodeB. Transmission of data may be in uplink (UL) for transmissions from a user equipment to a base station/node/network. Transmission of data may be considered in downlink (DL) for transmission from a base station/node/network to a user equipment. The target of transmission may generally be another radio node, in particular a radio node as described herein.

Communication data may be data intended for transmission. It may be considered that communication data comprises, and/or is of, one or more types of data. One type of data may be control data, which in particular may pertain to scheduling and/or measurements and/or configuring of radio nodes. Another type of data may be user data. Communication data may be data to be transmitted, which may be stored in a data buffer of the radio node for transmission.

The carrier may be a carrier of a carrier aggregate, in particular a secondary carrier. Alternatively or additionally, the carrier may be a LBT carrier and/or an unlicensed carrier. The term LAA (Licensed-Assisted Access) may generally refer to a carrier aggregation in which the primary carrier is a licensed carrier and at least one unlicensed carrier is a secondary carrier. Generally, the radio node may be adapted for LAA, and/or the carrier may be a secondary carrier of a LAA-CA.

A LBT procedure may comprise one or more Clear Channel Assessment (CCA, may also be called Clear Carrier Assessment) procedures—A CCA procedure may generally comprise sensing and/or determining the energy and/or power received on or for the channel or carrier (by the radio node) the LBT procedure is performed on over a time interval or duration, which may be called the CCA interval or duration. Generally, different CCA procedures may have different CCA intervals or durations, e.g. according to a configuration. The number of CCA procedure to be performed for a LBT procedure may be dependent on a random backoff counter. A CCA may indicate that a carrier or channel is idle if the power and/or energy sensed or determined is below a threshold, which may be a pre-determine threshold and/or be determined by the radio node, e.g. based on operating conditions and/or a configuration; if it is above or reaching the threshold, the carrier or channel may be indicated to be busy). A LBT procedure may be considered to determine that access to a carrier is allowed based on a number (e.g. a pre-determined number, e.g. according to a random backoff counter) of CCAs performed indicating that the carrier or channel is idle. In some cases, the number may indicate a number of consecutive indications of the carrier being idle. It may be generally considered that the radio node is adapted for such sensing and/or determining and/or for carrying out CCA, e.g. by comprising suitable sensor equipment and/or circuitry and/or a corresponding sensing module. Such a sensing module may be part of and/or be implemented as or in a LBT module. Performing a LBT procedure to determine whether accessing a carrier or channel is allowed may include performing one or more CCA procedures on that carrier or channel. The random backoff number may be based on a contention window size, which may indicated a range of numbers, e.g. integers, the random backoff number may be (randomly) determined from, e.g. a range of 0 or 1 up to the contention window size (CW). There may be defined a minimum value for the contention window size and/or a maximum number for the contention window size and/or a default value for the contention window size, which may e.g. the minimum value. The random backoff number may be an initial value for a random backoff counter, which may be counted down to zero every time a CCA procedure detects an idle carrier during a LBT procedure (the LBT and CCA procedures may pertain to and/or be performed for or on the same carrier).

There is disclosed a method for operating a radio node for a wireless communication network. The radio node is adapted for performing a Listen-Before-Talk, LBT, procedure to determine whether accessing at least one carrier for transmission of data is allowed. The method comprises adjusting the LBT procedure based on operating conditions, wherein adjusting the LBT procedure includes changing a contention window size and/or a random backoff number of the LBT procedure, and/or changing scheduling of data for the at least one carrier, and/or changing a defer period or arbitration interframe spaces.

Moreover, there is disclosed a radio node for a wireless communication network. The radio node is adapted for, and/or may comprise a LBT module for, performing a Listen-Before-Talk, LBT, procedure to determine whether accessing at least one carrier for transmission of data is allowed, wherein the radio node is further adapted for, and/or comprises an adjusting module for, adjusting the LBT procedure based on operating conditions. Adjusting the LBT procedure includes changing a contention window size and/or a random backoff number of the LBT procedure, and/or changing scheduling of data for the at least one carrier, and/or changing a defer period or arbitration interframe spaces.

Adjusting may be performed after at least on LBT procedure has been performed, e.g. with a predetermined set of parameters, in particular with a contention window size. Adjusting may comprise changing and/or modifying one or more such parameters, in particular the contention window size.

Transmitting data based on the LBT procedure and/or the adjusted LBT procedure may be performed. The radio node may be adapted accordingly and/or comprise a corresponding transmission module.

Changing scheduling of data may comprise scheduling data from the carrier the LBT procedure is performed for or on to another carrier, e.g. a primary carrier or LBT carrier, or vice versa.

The defer period may be a defer period of the LBT procedure and/or pertaining thereto.

The operating conditions may comprise or may be operating conditions pertaining to the carrier the LBT procedure is performed on.

It may be considered that the operating conditions pertain to the LBT procedure before transmission on the at least one carrier LBT procedure is performed on.

In one refinement, the operating conditions are not collisions and/or do not include collisions.

The LBT procedure may generally comprise a number of Clear Channel Assessments, wherein the number may be larger than one and/or be based on a random backoff number or counter. The counter may be based on the random backoff number, which may be based on a contention window size.

The operating conditions may include carrier activities and/or an adjustment history. An adjustment history may comprise information on adjustment (e.g. of LBT procedure parameters) already performed.

The at least one carrier may be a carrier of a carrier aggregate.

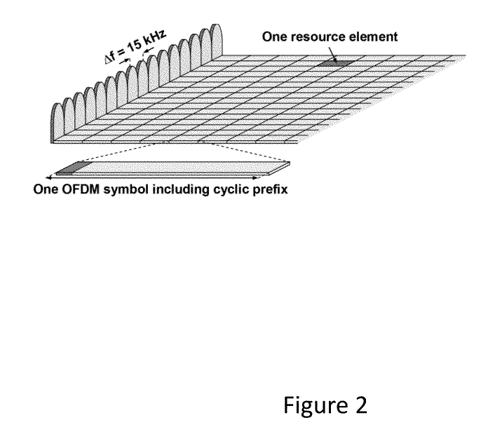

LTE uses OFDM in the downlink and DFT-spread OFDM (also referred to as single-carrier FDMA) in the uplink. The basic LTE downlink physical resource can thus be seen as a time-frequency grid as illustrated in FIG. 2, where each resource element corresponds to one OFDM subcarrier during one OFDM symbol interval. A carrier may comprise the number of subcarriers, e.g. 12 subcarriers. The uplink subframe has the same subcarrier spacing as the downlink and the same number of SC-FDMA symbols in the time domain as OFDM symbols in the downlink.

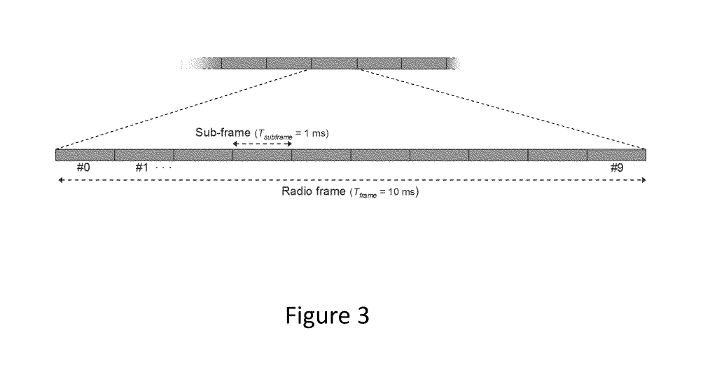

As indicated in FIG. 3, in the time domain, LTE downlink transmissions are organized into radio frames of 10 ms, each radio frame consisting of ten equally-sized subframes of length Tsubframe=1 ms. For normal cyclic prefix, one subframe consists of 14 OFDM symbols. The duration of each symbol is approximately 71.4 ρs. Thus, LTE provides a pre-defined time structure comprising subframes and/or frames and/or symbols as time units/intervals. The timing of the radio node/s in a wireless communication network, and/or the carrier/s, in particular according to LTE, may be maintained and/or defined relative to this time structure, which is provided and/or (pre-) defined by the network, e.g. a base station and/or a higher-level node or core network, e.g. relative to a reliable time source like a GPS signal and/or advance clock, e.g. an atomic clock.

Furthermore, the resource allocation in LTE is typically described in terms of resource blocks, where a resource block corresponds to one slot (0.5 ms, an example of another time unit/interval of the time structure) in the time domain and 12 contiguous subcarriers in the frequency domain. A pair of two adjacent resource blocks in time direction (1.0 ms) is known as a resource block pair. Resource blocks may be numbered in the frequency domain, starting with 0 from one end of the system bandwidth.

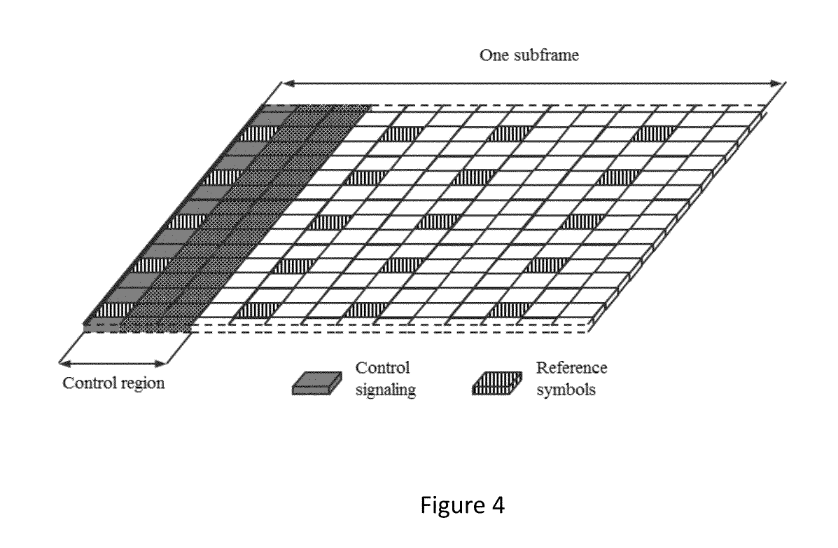

Downlink transmissions are dynamically scheduled, i.e., in each subframe the base station transmits control information about which user equipments or terminals data is transmitted to and upon which resource blocks the data is transmitted, in the current downlink subframe. This control signaling is typically transmitted in the first 1, 2, 3 or 4 OFDM symbols in each subframe and the number n=1, 2, 3 or 4 is known as the Control Format Indicator (CFI). The downlink subframe also contains common reference symbols, which are known to the receiver and used for coherent demodulation of e.g. the control information. A downlink system with CFI=3 OFDM symbols as control is illustrated in FIG. 4.

From LTE Rel-11 onwards, these resource assignments can be scheduled on the enhanced Physical Downlink Control Channel (EPDCCH) and the Physical Downlink Control Channel (PDCCH). For Rel-8 to Rel-10, the Physical Downlink Control Channel (PDCCH) is available.

The reference symbols shown in FIG. 4 are the cell specific reference symbols (CRS) and may be used to support multiple functions including fine time and frequency synchronization (in particular, to determine the timing according to the pre-defined time structure) and/or channel estimation for certain transmission modes. A control channel like the PDCCH/EPDCCH may be used to carry downlink control information (DCI) such as scheduling decisions and power-control commands. More specifically, the DCI may include:
Downlink scheduling assignments, including PDSCH resource indication, transport format, hybrid-ARQ information, and control information related to spatial multiplexing (if applicable). A downlink scheduling assignment may also include a command for power control of the PUCCH used for transmission of hybrid-ARQ acknowledgements in response to downlink scheduling assignments, and/or
Uplink scheduling grants, including PUSCH resource indication, transport format, and hybrid-ARQ-related information. An uplink scheduling grant also may include a command for power control of the PUSCH (physical Uplink Shared Channel); and/or
Power-control commands for a set of terminals as a complement to the commands included in the scheduling assignments/grants.

One PDCCH/EPDCCH may carry one DCI message containing one of the groups of information listed above. As multiple user equipments (UEs) and/or terminals can be scheduled simultaneously, and each can be scheduled on both downlink and uplink simultaneously, there must be a possibility to transmit multiple scheduling messages within each subframe. Each scheduling message is transmitted on separate PDCCH/EPDCCH resources, and consequently there are typically multiple simultaneous PDCCH/EPDCCH transmissions within each subframe in each cell. Furthermore, to support different radio-channel conditions, link adaptation can be used, where the code rate of the PDCCH/EPDCCH is selected by adapting the resource usage for the PDCCH/EPDCCH, to match the radio-channel conditions.

The LTE Rel-10 standard supports bandwidths larger than 20 MHz.

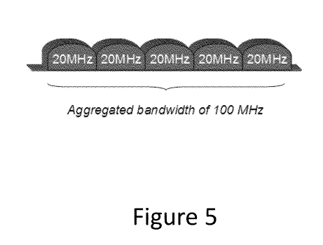

One important requirement on LTE Rel-10 is to assure backward compatibility with LTE Rel-8. This should also include spectrum compatibility. That would imply that an LTE Rel-10 carrier, wider than 20 MHz, should appear as a number of LTE carriers to an LTE Rel-8 terminal. Each such carrier can be referred to as a Component Carrier (CC). In particular for early LTE Rel-10 deployments it can be expected that there will be a smaller number of LTE Rel-10-capable terminals compared to many LTE legacy terminals. Therefore, it is necessary to assure an efficient use of a wide carrier also for legacy terminals, i.e. that it is possible to implement carriers where legacy terminals can be scheduled in all parts of the wideband LTE Rel-10 carrier. The straightforward way to obtain this would be by means of Carrier Aggregation (CA). CA implies that an LTE Rel-10 terminal can receive multiple CC, where the CC have, or at least the possibility to have, the same structure as a Rel-8 carrier. CA is illustrated in FIG. 5. A CA-capable UE is assigned a primary cell (PCell) which is always activated and may comprise a primary carrier, and one or more secondary cells (SCells) which may be activated or deactivated dynamically and/or may comprise one or more secondary carriers, in particular LBT carrier/s.

The number of aggregated carriers (component carriers, CC) in a CA as well as the bandwidth of the individual CC may be different for uplink and downlink. A symmetric configuration refers to the case where the number of CCs in downlink and uplink is the same whereas an asymmetric configuration refers to the case that the number of CCs is different. The number of carriers/CCs configured in a cell may be different from the number of CCs seen by a UE/terminal: A UE/terminal may for example support more downlink CCs than uplink CCs, even though the cell is configured with the same number of uplink and downlink CCs.

In addition, carrier aggregation may provide the ability to perform cross-carrier scheduling. This mechanism allows a (E)PDCCH on one CC to schedule data transmissions on another CC by means of a 3-bit Carrier Indicator Field (CIF) inserted at the beginning of the (E)PDCCH messages. For data transmissions on a given CC, a UE expects to receive scheduling messages on the (E)PDCCH on just one CC—either the same CC, or a different CC via cross-carrier scheduling; this mapping from (E)PDCCH to PDSCH is also configured semi-statically. Such cross-carrier scheduling may be performed on a primary carrier.

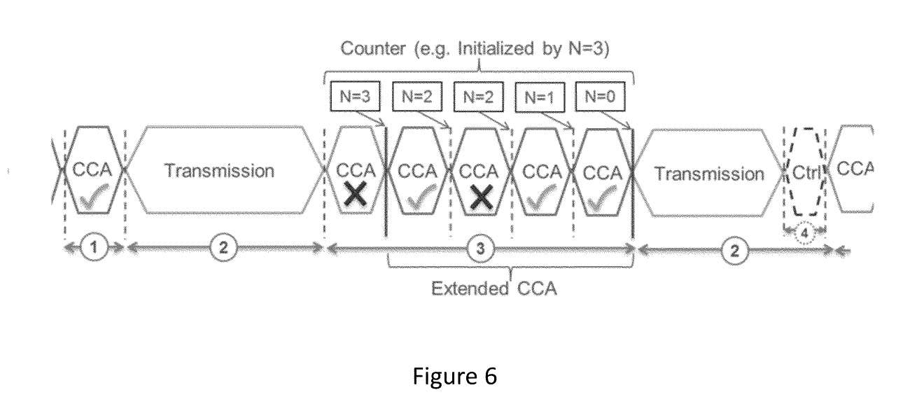

Generally, the following may be considered as an example for a LBT procedure. As shown in FIG. 6, it may be considered that before accessing a carrier or channel, in particular before a transmission or a burst of transmissions on the carrier or channel, a Clear Channel Assessment (CCA) procedure or check may be performed, e.g. using “energy detect” and/or sensing or determining the power or energy on the carrier or channel.

This may include observing or sensing or detecting for the duration of the CCA observation time (or CCA interval or duration), which may be at least 20 μs. The CCA observation time or interval used may be declared by the manufacturer of the radio node. The carrier or channel may be considered occupied (“Busy”) if the energy/power level in the channel exceeds a threshold corresponding to the power level given below. If the carrier or channel is found to be clear (“Idle”), the carrier may be accessed immediately.

If the carrier or channel is occupied, the radio node shall not transmit in that carrier or channel. The radio node may perform an Extended CCA check in which the carrier or channel may be observed for the duration of a random factor N (random backoff number) multiplied by the CCA observation time or CCA interval. N may define the number of clear/idle slots (which may result) in a total Idle Period) that need to be observed before initiation (starting) of transmission. The value of N shall be randomly selected in the range 1 . . . q every time an Extended CCA is required and the value stored in a counter. The value of q is selected by the manufacturer in the range 4 . . . 32. This selected value shall be declared by the manufacturer. The counter is decremented every time a CCA slot is considered to be “unoccupied” or idle. When the counter reaches zero, the equipment may transmit.

The radio node may be allowed to continue Short Control Signalling Transmissions on this channel providing it complies with certain requirements.

For a radio node having simultaneous transmissions on multiple (adjacent or non-adjacent) carriers or channels, the radio node may continue transmissions on other carriers providing the CCA check did not detect any signals on those carriers.

The total time (transmission time or transmission interval) that a radio node may transmit on a carrier or channel is the Maximum Channel Occupancy Time or Maximum Occupancy time, which may be less than (13/32)×q ms, with q as defined above, after which the radio node may perform the Extended CCA/LBT procedure again. Generally, the total time a carrier is transmitted on (duration of the initial signal/signal for occupying the carrier plus time for transmission of communication data), may be equal to or less than a maximum occupancy time.

A radio node, upon correct reception of a packet which was intended for it, may skip CCA and immediately proceed with the transmission of management and control frames (e.g. ACK and Block ACK frames). A consecutive sequence of transmissions by the radio node, without it performing a new CCA/LBT procedure, may not exceed the Maximum Channel Occupancy Time.

For the purpose of multi-cast, the ACK transmissions (associated with the same data packet) of the individual devices are allowed to take place in a sequence

As an example, the energy detection threshold for the CCA may be proportional to the maximum transmit power (PH) of the transmitter (radio node): for a 23 dBm e.i.r.p. transmitter the CCA threshold level (TL) may be equal or lower than −73 dBm/MHz at the input to the receiver (assuming a 0 dBi receive antenna). For other transmit power levels, the CCA threshold level TL may be calculated using the formula: TL=−73 dBm/MHz+23−PH (assuming a 0 dBi receive antenna and PH specified in dBm e.i.r.p.).

Up to now, the spectrum used by LTE is dedicated to LTE. This has the advantage that an LTE system does not need to care about coexistence with other non-3GPP radio access technologies in the same spectrum and spectrum efficiency can be maximized. However, the spectrum allocated to LTE is limited which cannot meet the ever increasing demand for larger throughput from applications/services. Therefore, a new study item has been initiated in 3GPP on extending LTE to exploit unlicensed spectrum in addition to licensed spectrum.

With Licensed-Assisted Access to unlicensed spectrum, as shown in 7, a UE is connected to a PCell in the licensed band/on a licensed carrier (primary carrier) and one or more SCells in the unlicensed band/on a unlicensed carrier. A secondary cell in unlicensed spectrum may be denoted as LAA secondary cell (LAA SCell). The LAA SCell may operate in DL-only mode or operate with both UL and DL traffic. Furthermore, in future scenarios the radio nodes may operate in standalone mode in license-exempt channels without assistance from a licensed cell. Unlicensed spectrum can, by definition, be simultaneously used by multiple different technologies. Therefore, the use of unlicensed carriers, in particular LAA as described herein, may consider coexistence with other systems.

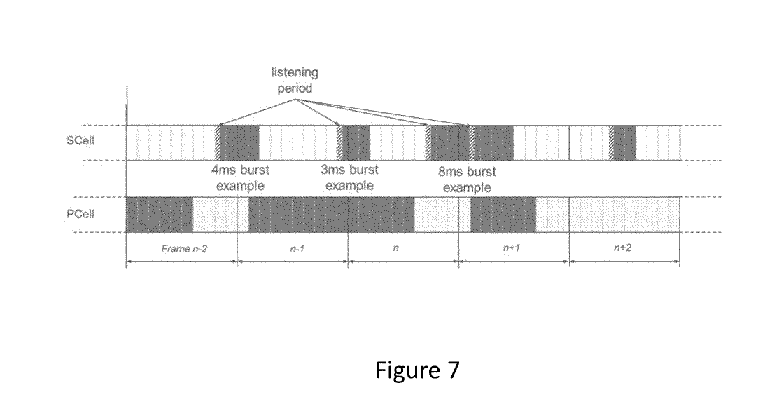

To coexist fairly with the Wi-Fi system, transmission on the SCell shall conform to LBT protocols in order to avoid collisions and causing severe interference to on-going transmissions. This includes both performing LBT before commencing transmissions, and limiting the maximum duration of a single transmission burst (to a transmission interval). The maximum transmission burst duration is specified by country and region-specific regulations, for e.g., 4 ms in Japan and 13 ms according to EN 301.893. An example in the context of LAA is shown in FIG. 7 with different examples for the duration of a transmission burst on the LAA SCell constrained by a maximum allowed transmission duration of 4 ms.

Generally, the LBT procedure (which may be called load based LBT or load based LBT protocol) may be carried out for any carrier, in particular on a carrier for data transmissions that are carried for example on the PDSCH or PUSCH of an LAA transmitting node on SCell. In the approach presented here, for a new LBT attempt a random number N may be drawn from a contention window, which may be used to initialize and/or determine a random backoff counter. The carrier or channel may be sensed to determine CCA idle slots. If an idle slot is detected, the random backoff counter is decremented. When the counter reaches zero, the transmission can immediately occur.

A description of the proposed random backoff and/or contention window selection techniques for LBT protocols follows. This is generally applicable for both DL and UL transmissions in both FDD and TDD systems. In the following, the contention window from which a random backoff counter can be drawn for a new LBT attempt is represented by CW so that the counter drawn falls within [0, CW]. The default random backoff contention window size is denoted by CWmin.

A LBT procedure may be performed for a carrier intended for data transmissions, which may e.g. be carried for example on the PDSCH or PUSCH. In the first embodiment, the information that reflects the activities on the channel can be used by a radio node (transmitting node) to adjust the contention window size, CW, of the LBT protocol. The transmitting node can take into account this information with consideration in its need for accessing the carrier or channel to serve the incoming traffic and also its past record of carrier or channel utilization.

One or more operating conditions may comprise and/or pertain to carrier or channel activities and/or corresponding information. Any one or any combination of the following operation conditions or corresponding types of information may be used as basis on which to adjust the LBT procedure or protocol, in particular the contention window size.

Channel or carrier activities and/or corresponding information may be determined based on and/or comprise and/or be represented by
information on channel or carrier activities, e.g obtained via measurements done at the radio node or transmitting node itself, and/or measurement reports provided to the radio node or transmitting node by other entities or radio nodes, e.g. UEs. Examples of such measurements include interference measurements; and/or
information on the carrier or channel activities extracted from and/or based on the outcome of the channel sensing operations and/or CCA procedures and/or corresponding CCA results, e.g. for performed LBT procedures by the radio node or transmitting node and/or other radio nodes or transmitting nodes; such information may be signaled to the radio node by the other nodes. For example, CCA procedures or channel sensing operations can provide information on the fractions of time the carrier or channel is sensed to be idle or occupied/busy, as well as how frequently idle periods are interrupted by other transmissions; and/or
information pertaining to the history of carrier or channel activities, e.g. stored corresponding data or information; and/or
information regarding the relevance of the information channel or carrier activities, e.g. regarding their age and/or that they are not outdated, e.g. in order to have an implication on adjusting or modifying the LBT procedure or protocol parameters such as the contention window size, CW; and/or
information on the rate and/or QoS of incoming traffic has been served, for example by using the buffer occupancy metric, and/or the rate of the incoming traffic itself, e.g., to consider for adjusting/tuning the LBT protocol or procedure or corresponding parameters, e.g. to potentially influence the efficiency of accessing the channel; and/or
information pertaining to the carrier and/or channel activities related to information on the number of radio nodes trying to access the carrier or channel. For example, the nodes belonging to a particular serving AP or belonging to the same operator or even detected nodes belonging to another system or technology; and/or
information pertaining to previous changes of the contention window size (e.g., as adjusting history information), which e.g. can be used for adapting the next contention window size; and/or
information on the previous number of retransmissions with and/or of the contention window size, which e.g. can be used to adapt the subsequent contention window sizes.

One or any combination of the above examples on the information can be used to determine how to adjust the LBT procedure and/or the contention window size in the LBT procedure.

The following non-limiting embodiments pertain to a specific case of the general description of the invention: the (random backoff) contention window size used by an LBT procedure or attempt may be a function of the history of carrier or channel activities and/or served traffic, and the incoming traffic.

If the transmitting node hardly succeeds to detect any idle channel slots when performing channel sensing for a long enough time interval, it can be assumed that that the transmitting node is starved and has been greatly disadvantaged in having access to the carrier or channel. One non-limiting example to identify the starvation situation is by means of some threshold value/s that can be configurable such as X and Ts, e.g. such that if a radio or transmitting node senses the carrier or channel to be occupied without at most X interruptions by idle periods for a time duration of at least Ts, then the node is declared to be starved. For example, X=floor(N/a), where N is the random backoff counter drawn which falls within [0, CW] and a is a positive integer number or X is a fixed non-negative integer number.

Generally, based on the detection of starvation (for example, as described above), and/or based on operating conditions like carrier activities, one or more of the following adjustments may be performed:
Re-selection of another channel or carrier; and/or
Adoption of minimum contention window or contention window size; and/or
Increase of contention window size; and/or
Increase or decrease any defer periods or arbitration interframe spaces used in the LBT protocol. The defer period generally denotes the period of time a node must remain inactive without transmitting after a busy channel has just turned idle; and/or
Change of scheduling policy in the eNB to try to schedule more data on the licensed carrier in a LAA setup.

The adjustment or combination of adjustments or policy choice can be dependent on the served and incoming traffic situation at the radio node or transmitting node. For example, if a node is experiencing low load, it may increase the contention window size. On the other hand, if a node is experiencing medium or high buffer occupancy and/or medium or high traffic loads, it may decrease the contention window size even to the minimum value or try using another carrier or channel for transmission.

In another non-limiting embodiment, the relevant/recent history on carrier or channel activities obtained from previously attempted or performed LBT procedures and/or based on measurements can be used to select the contention window. As a non-limiting example, if the statistics corresponding to the channel activities are obtained not earlier than Tmax, where Tmax is a configurable time interval parameter, they can be taken into account. Otherwise, the carrier or channel activities respectively the corresponding information may be determined or considered outdated. In this case, the contention window size may be adapted to its minimum value or default value.

For illustration it may be assumed that the carrier or channel activities history may be obtained from the carrier or channel sensing statistics that are obtained from the previously attempted LBT, in particular such that all of them are not older than Tmax.

A previous LBT procedure with contention size CW and drawn random backoff number N may be considered. If in that LBT procedure or attempt with random backoff number N, the countdown of N idle slots has been interrupted more than M times due to observing occupied carrier or channel (with corresponding CCA procedures), the contention window size may be increased, otherwise it may be reset to its minimum value or default value or, alternatively, another carrier or channel may be selected for transmission, e.g. another LBT carrier or channel or a licensed carrier or channel and/or a primary carrier. Note that each of the M interruptions may be counted as an instance where countdown is interrupted by detection of transmissions by another node. Some non-limiting examples for determining M=f(N) are the following:

M can be set or configured as a fixed positive value. One nonlimiting example is M=2.

M can be set or configured in proportional to the random backoff number N. One nonlimiting example is M=j*N, where j is a positive factor and configurable.

M can be set or configured in proportional to the current contention backoff window size CW. One nonlimiting example is M=k*CW, where k is a positive factor and configurable.

M can be determined by and/or based on the random backoff number N via an m-th order polynomial with configurable coefficients:

e.g., f(N)=bₘN^{m}+bₘ₋₁+N^{m-1}+ . . . +_b₁N+b₀

In another non-limiting embodiment, if the buffer occupancy of the radio node or transmitting node has increased to a threshold Bmax, wherein Bmax is a configurable threshold, one or more of the following adjustments or policies may be performed:
Re-selection of another channel or carrier, e.g. another LBT carrier and/or a primary carrier in LAA; and/or
Adoption of a minimum or default contention window or window size; or
Increase of the contention window size.

The policy choice and/or the adjustment performed may be dependent on the served and/or incoming traffic situation at the radio node or transmitting node. For example, if the node is experiencing low load, it can increase the contention window size. On the other hand, if the node experiencing medium or high traffic loads may decrease the contention window size even to the minimum or default value or try using another channel for transmission.

In the above embodiments, when the contention window size is adjusted, an adaptive scheme for the selection of the contention window size may be considered or performed, e.g. when the minimum window size CWmin can be made to take effect based on a number of conditions or factors similar to those mentioned in the previous section, such as the total number of nodes associated to a serving node such as the number of UEs served by an eNB, traffic situation, interference/average detected energy, number of retransmissions, history of the current CW size. Essentially window size expansion/contraction function can be binary exponential, moving average, or any other.

Weights may be associated with the factors or conditions, e.g., number of active UEs, buffer occupancy, number of retransmissions, fraction of time channel being above a threshold, the fraction of times idle periods being interrupted, etc. Depending upon the last encountered situation, a readjustment in the weighting factor may be carried out.

For example, the contention window or its size can be adjusted to and/or determined based on the previous contention window sizes:

CW(n+1)=g(CW(n−k), . . . ,CW(n),CWmin),

where k>0

As an example:

Multiplicative increase of the contention window, i.e.

CW(n+1)=min(d*CW(n),CWmax)

For example d=2 represents doubling the contention window or its size. Increase the contention window by a fixed value, i.e. CW(n+1)=min(CW(n−1)+CW0,CWmax)
For example CW0=CWmin

As another example, the contention window or its size can be determined by:

CW(n+1)=floor((w1*Numberof_UEs+w2*Buffer_occupancy+w3.ReTxCntr)*CW(n))

wherein for example, if at an instant, buffer occupancy increases, the weight w2 can be correspondingly increased. In contrast, if the buffer occupancy is decreased, w2 may be decreased. If more UEs are associated or a number of retransmissions increase, the corresponding weights w1, w3 may go up). Heuristics (based on some measurements and logic) could be used to initialize and update weighting factors.

The new contention window can be a weighted function of the channel observed variables:

CW(n+1))=h(f(N),CWmin)

where the CWmin and CWmax are the minimum and maximum configured values for the contention window, respectively.

In another non-limiting embodiment, one or more of the above actions or adjustments are performed only if the devices occupying the channel belong to a particular radio access technology. For example, the contention window may be adjusted if the node performing LBT determines or is informed that the carrier or channel is continually being occupied by Wi-Fi nodes.

Alternatively or additionally, different contention window sizes may be determined and/or defined and/or maintained and/or adapted for different types of data and/or based on the type of data to be transmitted. A possible type of data may be user data.

Control data comprising management and/or control information may another type of data. Non-limiting examples of management and control information are Discovery Reference Signal (DRS) transmissions, or master information block (MIB) and/or system information block (SIB) signals.

The contention window size for control data like management and control information may be fixed, while the contention window size for user data may be adapted and/or adjusted as outlined above.

In another embodiment, the contention window size for control data like management and control information may be adapted and/or adjusted with a growth rate lower than a growth rate for user data. As a non-limiting example, a multiplicative factor for control data like management and control information respectively for the corresponding contention window size may be set to a smaller value than that for user data respectively the corresponding window size.

As a further nonlimiting example, the contention window size for control data like management and control information may be adapted or adjusted with a polynomial functional form, while that for user data may be adapted or adjusted with exponential functional form.

Alternatively or additionally, different contention window sizes may be maintained and/or adapted or adjusted for different SCells, e.g. in a multi-carrier and/or CA and/or LAA arrangement.

In another embodiment, the network may configure the transmission on a set of SCells to be considered together. For example, the network may configure a scheduling command to be applicable to a set of SCells simultaneously. For such case, contention window sizes may be maintained and/or adapted and/or adjusted for said set of SCells together.

According to this embodiment, different random backoff window sizes are maintained and adapted for different quality of service (QoS) classes or importance classes.

Nonlimiting examples of QoS are associated to voice conversation and video conferencing services. Higher layer control information may be carried by PDSCH or PUSCH as data transmission but may be treated with higher importance to ensure correct system operation and control.

A load metric may be considered as follows:

Example definition of buffer occupancy (BO)

The packet arrival rate for the measured BO of the non-replaced (data) may be used as a metric do define the packet arrival rate at or for a radio node, e.g. in a Wi-Fi or LAA system. Below follow examples of definitions of BO.

For DL-only in LAA:
For an eNB or base station, the buffer occupancy of the i-th small cell/UE (Wi-Fi & LAA)=sum of the period of time during which the i-th small cell/UE has data to transmit including retransmissions (i.e., its queue is not empty)/measurement time;
Average buffer occupancy of the i-th small cell/UE (Wi-Fi & LAA)=sum of the period of time during which the i-th small cell/UE has data to transmit including retransmissions (i.e., its queue is not empty)/measurement time
For DL+UL in LAA or WiFi:
For a UE, compute the fraction of time that a UE's buffer was not empty within a given time interval.
The eNB can collect the measurement of BO statics from a its served UEs or calculate itself based on buffer status reports, then contact the same calculate as mentioned above for each UE it serves (can be done per cell per UE or per UE).
For an eNB, compute the fraction of the total time that the eNB/AP's buffer was not empty under given time interval.
For an AP/eNB, compute the fraction of total simulation time that any UE served by the cell had a packet in its buffer for transmission on the UL.

Final metric:
Buffer occupancy of the i-th small cell (Wi-Fi & LAA)=sum of the period of time during which at least one of the i-th small cell and UEs (belonging to the i-th small cell) has data to transmit including retransmissions (i.e., its queue is not empty)/measurement time

Example of Served Vs. Offered Traffic

Instead or in addition to the buffer occupancy, the metric of served vs. offered (or incoming) traffic can be used. The served and offered traffic can be measured by the serving eNB per cell and/or per UE. The served traffic may be represented by the amount of data that flows to or from the UEs, and/or the corresponding data rate. The offered traffic may be represented by the amount of data that is the inflow to the system, and/or the corresponding data rate. The metric that can be used is for example the quota or ratio between served and offered traffic. The quota or ratio may be compared to the above mentioned thresholds.

There are generally describes a number of schemes for the selection or adjusting and/or tuning of the contention window size, which in turn influences the system performance characteristics and its coexistence behavior with other collocated networks/technologies. Parameters based on which the contention window size may be determined or adjusted and/or affecting the contention window size include traffic characteristics/patterns, QoS parameters for different traffic classes, observed spectral conditions and the variation of the above factors over time. Moreover, cases wherein a node directly measures/observes the influencing parameters/metrics and acquires them implicitly from other nodes through exchange of information are disclosed.

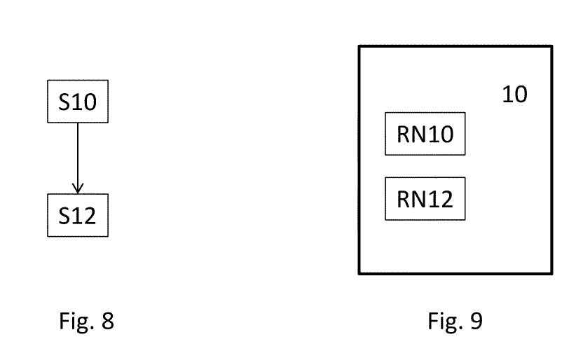

FIG. 8 shows a method for operating a radio node, e.g. a network node like a base station or user equipment as described herein. In (optional) action S10, a LBT procedure may be performed on at least one carrier, e.g. as described herein. In action S12, the LBT procedure may be adjusted, e.g., as described herein.

FIG. 9 shows a radio node 10. The radio node 10 comprises a LBT module RN10 for performing action S10, and a adjusting module RN12 for performing action S12.

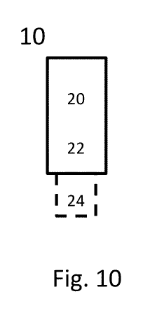

FIG. 10 schematically shows a radio node 10, which may be implemented in this example as a user equipment or eNodeB. Radio node 10 comprises control circuitry 20. Radio node 10 also comprises radio circuitry 22 providing receiving and transmitting or transceiving functionality, the radio circuitry 22 being connected or connectable to the control circuitry 20. An antenna circuitry 24 may be connected or connectable to the radio circuitry 22, e.g. to collect or send and/or amplify signals. Radio circuitry 22 and the control circuitry 20 controlling it (and, e.g. the antenna circuitry) are configured for cellular communication with a network or a network node, in particular for transmitting on at least one carrier and to perform LBT and/or CCA procedures this carrier. The radio node 10 may be adapted to carry out any of the methods for operating a radio node disclosed herein; in particular, it may comprise corresponding circuitry, e.g. control circuitry. Modules or functionality of a radio node as described herein may be implemented in software and/or hardware and/or firmware in corresponding circuitry.

Generally, control circuitry may comprise integrated circuitry for processing and/or control, e.g. one or more processors and/or processor cores and/or FPGAs (Field Programmable Gate Array) and/or ASICs (Application Specific Integrated Circuitry). Control circuitry may comprise and/or be connected to and/or be adapted for accessing (e.g. writing to and/or reading from) memory, which may comprise any kind of volatile and/or non-volatile memory, e.g. cache and/or buffer memory and/or RAM (Random Access Memory) and/or ROM (Read-Only Memory) and/or optical memory and/or EPROM (Erasable Programmable Read-Only Memory). Such memory may be adapted to store code executable by control circuitry and/or other data, e.g. data pertaining to communication, e.g. configuration/s and/or address data of nodes, etc. Control circuitry may be adapted to control any of the methods described herein and/or to cause such methods to be performed, e.g. by the radio node. Corresponding instructions may be stored in the memory, which may be readable and/or readably connected to the control circuitry.

Radio circuitry may comprise receiving circuitry (e.g. one or more receivers) and/or transmitting circuitry (e.g. one or more transmitters). Alternatively or additionally, radio circuitry may comprise transceiving circuitry for transmitting and receiving (e.g. one or more transceivers). It may be considered that radio circuitry comprises a sensing arrangement for performing LBT/CCA. Antenna circuitry may comprise one or more antennas or antenna elements, which may be arranged in an antenna array.

Configuring a radio node, in particular a user equipment, may refer to the radio node being adapted or caused or set to operate according to the configuration. Configuring may be done by another device, e.g. a network node (for example, a radio node of the network like a base station or eNodeB) or network, in which case it may comprise transmitting configuration data to the radio node to be configured. Such configuration data may represent the configuration to be configured and/or comprise one or more instruction pertaining to a configuration, e.g. regarding a freeze interval and/or a transmission start interval. A radio node may configure itself, e.g. based on configuration data received from a network or network node.

Generally, configuring may include determining configuration data representing the configuration and providing it to one or more other nodes (parallel and/or sequentially), which may transmit it further to the radio node (or another node, which may be repeated until it reaches the wireless device). Alternatively or additionally, configuring a radio node, e.g. by a network node or other device, may include receiving configuration data and/or data pertaining to configuration data, e.g. from another node like a network node, which may be a higher-level node of the network, and/or transmitting received configuration data to the radio node. Accordingly, determining a configuration and transmitting the configuration data to the radio node may be performed by different network nodes or entities, which may be able to communicate via a suitable interface, e.g. an X2 interface in the case of LTE.

A carrier may comprise a continuous or discontinuous radio frequency bandwidth and/or frequency distribution, and/or may carry, and/or be utilized or utilizable for transmitting, information and/or signals, in particular communication data. It may be considered that a carrier is defined by and/or referred to and/or indexed according to for example a standard like LTE. A carrier may comprise one or more subcarriers. A set of subcarriers (comprising at least one subcarrier) may be referred to as carrier, e.g. if a common LBT procedure (e.g. measuring the total energy/power for the set) is performed for the set. A channel may comprise at least one carrier. Accessing a carrier may comprise transmitting on the carrier. If accessing a carrier is allowed, this may indicate that transmission on this carrier is allowed.

A storage medium may generally be computer-readable and/or accessible and/or readable by control circuitry (e.g., after connecting it to a suitable device or interface), and may comprise e.g. an optical disc and/or magnetic memory and/or a volatile or non-volatile memory and/or flash memory and/or RAM and/or ROM and/or EPROM and/or EEPROM and/or buffer memory and/or cache memory and/or a database and/or an electrical or optical signal.

The terms “interval” and “period” may be used interchangeably throughout this disclosure.

An LAA node may be a radio node adapted for LAA.

Defining an LBT parameter, in particular a freeze period, may comprise determining the parameter.

In this description, for purposes of explanation and not limitation, specific details are set forth (such as particular network functions, processes and signaling steps) in order to provide a thorough understanding of the technique presented herein. It will be apparent to one skilled in the art that the present concepts and aspects may be practiced in other embodiments and variants that depart from these specific details.

For example, the concepts and variants are partially described in the context of Long Term Evolution (LTE) or LTE-Advanced (LTE-A) mobile or wireless communications technologies; however, this does not rule out the use of the present concepts and aspects in connection with additional or alternative mobile communication technologies such as the Global System for Mobile Communications (GSM). While the following embodiments will partially be described with respect to certain Technical Specifications (TSs) of the Third Generation Partnership Project (3GPP), it will be appreciated that the present concepts and aspects could also be realized in connection with different Performance Management (PM) specifications.

Moreover, those skilled in the art will appreciate that the services, functions and steps explained herein may be implemented using software functioning in conjunction with a programmed microprocessor, or using an Application Specific Integrated Circuit (ASIC), a Digital Signal Processor (DSP), a Field Programmable Gate Array (FPGA) or general purpose computer. It will also be appreciated that while the embodiments described herein are elucidated in the context of methods and devices, the concepts and aspects presented herein may also be embodied in a program product as well as in a system comprising control circuitry, e.g. a computer processor and a memory coupled to the processor, wherein the memory is encoded with one or more programs or program products that execute the services, functions and steps disclosed herein.

It is believed that the advantages of the aspects and variants presented herein will be fully understood from the foregoing description, and it will be apparent that various changes may be made in the form, constructions and arrangement of the exemplary aspects thereof without departing from the scope of the concepts and aspects described herein or without sacrificing all of its advantageous effects. Because the aspects presented herein can be varied in many ways, it will be recognized that any scope of protection should be defined by the scope of the claims that follow without being limited by the description.

| Abbreviation | Explanation |
|---|---|
| ACK | Acknowledgement |
| AP | Access Point |
| ARQ | Automated Repeat reQuest |
| CCA | Clear Channel Assessment |
| CFP | Contention Free Period |
| CIF | Carrier Indicator Field |
| CW | Contention Window |
| DCF | Distributed Coordination Function |
| DIFS | DCF Inter-frame Spacing |
| DL | Downlink |
| DRS | Discovery Reference Signal |
| eNB | evolved NodeB, base station |
| HARQ | Hybrid ARQ |
| LAA | Licensed Assisted Access |
| LBT | Listen Before Talk |
| MIB | Master Information Block |
| PDCCH | Physical Downlink Control Channel |
| PIFS | PCF Inter-frame Spacing |
| PUSCH | Physical Uplink Shared Channel |
| QCI | QoS Class Identifier |
| QoS | Quality of Service |
| SCell | Secondary Cell |
| SIB | System Information Block |
| SIFS | Short Inter-frame Spacing |
| STA | Station |
| TTI | Transmission-Time Interval |
| UE | User Equipment |
| UL | Uplink |

1-17. (canceled)

18. A method for operating a radio node for a wireless communication network, the radio node being adapted for performing a Listen-Before-Talk (LBT) procedure to determine whether accessing at least one carrier for transmission of data is allowed, the method comprising:
adjusting the LBT procedure based on operating conditions, wherein adjusting the LBT procedure includes:
changing a contention window size and/or a random backoff number of the LBT procedure; and/or
changing scheduling of data for the at least one carrier; and/or
changing a defer period or arbitration interframe spaces.

19. The method of claim 18, wherein the operating conditions comprise operating conditions pertaining to the carrier the LBT procedure is performed on.

20. The method of claim 18, wherein the operating conditions pertain to the LBT procedure before transmission on the at least one carrier LBT procedure is performed on.

21. The method of claim 18, wherein the operating conditions are not collisions.

22. The method of claim 18, wherein the LBT procedure comprises a number of Clear Channel Assessments, wherein the number may be larger than one and/or be based on a random backoff number or counter.

23. The method of claim 18, wherein the operating conditions include carrier activities and/or an adjustment history.

24. The method of claim 18, wherein the at least one carrier is a carrier of a carrier aggregate.

25. A radio node for a wireless communication network, the radio node comprising:
radio circuitry; and
control circuitry configured to control the radio circuitry and to:
perform a Listen-Before-Talk (LBT) procedure, using the radio circuitry, to determine whether accessing at least one carrier for transmission of data is allowed; and
adjust the LBT procedure based on operating conditions;
wherein the control circuitry is configured so that adjusting the LBT procedure includes:
changing a contention window size and/or a random backoff number of the LBT procedure; and/or
changing scheduling of data for the at least one carrier; and/or
changing a defer period or arbitration interframe spaces.

26. The radio node of claim 25, wherein the operating conditions comprise operating conditions pertaining to the carrier the LBT procedure is performed on.

27. The radio node of claim 25, wherein the operating conditions pertain to the LBT procedure before transmission on the at least one carrier LBT procedure is performed on.

28. The radio node of claim 25, wherein the operating conditions are not collisions.

29. The radio node of claim 25, wherein the LBT procedure comprises a number of Clear Channel Assessments, wherein the number may be larger than one and/or be based on a random backoff number or counter.

30. The radio node of claim 25, wherein the operating conditions include carrier activities and/or an adjustment history.

31. The radio node of claim 25, wherein the at least one carrier is a carrier of a carrier aggregate.

32. A wireless communication system comprising the radio node of claim 25.

33. A non-transitory computer-readable medium comprising, stored thereupon, a computer program product comprising code executable by control circuitry in a radio node comprising the control circuitry and radio circuitry, wherein the code is configured so as to cause the control circuitry, when executing the code, to
perform a Listen-Before-Talk (LBT) procedure, using the radio circuitry, to determine whether accessing at least one carrier for transmission of data is allowed; and
adjust the LBT procedure, based on operating conditions, in such a way that adjusting the LBT procedure includes:
changing a contention window size and/or a random backoff number of the LBT procedure; and/or
changing scheduling of data for the at least one carrier; and/or
changing a defer period or arbitration interframe spaces.
